(19) United States
(12) Patent Application Publication
(10) Pub. No.: US 2015/0302557 A1
(43) Pub. Date: Oct. 22, 2015

(54) METHOD AND APPARATUS FOR EVENT DETECTION USING FRAME GROUPING

(71) Applicants: CENTER FOR INTEGRATED SMART SENSORS FOUNDATION, Daejeon (KR); HANDONG GLOBAL UNIVERSITY INDUSTRY-ACADEMIC COOPERATION FOUNDATION, Pohang-si (KR)

(72) Inventors: Kang Yi, Pohang-si (KR); Chong Min Kyung, Daejeon (KR); Chul Hui Lee, Daejeon (KR); Jong Ho Park, Daejeon (KR)

(21) Appl. No.: 14/688,464

(22) Filed: Apr. 16, 2015

(30) Foreign Application Priority Data
Apr. 17, 2014 (KR) 10-2014-0045811

(51) Int. Cl. G06T 5/00; G06T 7/00

(52) U.S. Cl. CPC G06T 5/002; G06T 7/0081; G06T 2207/10004; G06T 2207/20182

(57) ABSTRACT

An event detection method using frame grouping according to time and an apparatus therefor are provided. The event detection method includes generating a plurality of images by successively capturing objects using a plurality of frames, wherein the plurality of frames are grouped into a plurality of groups based on whether the plurality of frames have the same or similar amounts of exposure, grouping images generated with frames corresponding to each of the plurality of groups, and determining whether a previously defined event occurs using the grouped images.

### CROSS-REFERENCE TO RELATED APPLICATIONS

A claim for priority under 35 U.S.C. §119 is made to Korean Patent Application No. 10-2014-0045811 filed Apr. 17, 2014, in the Korean Intellectual Property Office, the entire contents of which are hereby incorporated by reference.

### BACKGROUND

Embodiments of the inventive concepts described herein relate to a method of detecting events in images and an apparatus therefor, and more particularly, to a method of detecting events of under-exposure and saturation regions using an amount of exposure.

According to the related art, a typical camera sensor system operates using a method of converting light input from the outside into electric signals in its respective pixels and measuring an amount of light using levels of the electric signals. In more detail, in a first step, photons are converted into charges and the converted charges are accumulated in respective pixels during a certain exposure time. In a second step, the charges accumulated in the respective pixels are read out and an amount of the read charges accumulated in the respective pixels is measured to configure images. Herein, if the exposure time is too short, because of little value difference between pixels and noises, there is a problem in that it is difficult for users to recognize the configured image. If the exposure time is too long, because a maximum amount of charges which may be accumulated in respective pixels is saturated, there is a problem in that users may not recognize the configured images. To solve these problems, a conventional automatic exposure method includes an exposure measuring unit. The typical camera sensor system includes pixels for receiving light and generating electric signals of images, and an image signal processing unit for improving the signals by a procedure such as noise cancellation and color correction. In general, the exposure measuring unit is configured as a part of the image signal processing unit.

The exposure measuring unit receives an output of the image sensor or a result of signaling a part of the output in a specific time and measures a maximum pixel value of the entire or partial region of a picture. The exposure measuring unit determines an exposure time in the specific time thereafter based on the pixel value and a current exposure time and feeds the determined exposure time back to the image sensor. The image sensor avoids under-exposure and saturation by accumulating charges in pixels by the determined exposure time. However, although exposure is adjusted by the conventional automatic exposure method, when a dark portion and a bright portion are mixed in an image itself, in case of avoiding saturation, it may not be avoided that under-exposure occurs in the dark portion. In the other hand, in case of avoiding under-exposure, it may not be avoided that the bright portion is saturated. Exposure may be adjusted on a partial region where a main body exists and under-exposure or saturation may be accepted in another object, in general image capturing or video capturing. However, there is a limit in this automatic exposure method when an important object may not be specified or events which occur in a dark portion and a bright portion must be detected in monitoring cameras and the like.

### SUMMARY

Embodiments of the inventive concepts provide a method of detecting events in a region where it is impossible to recognize an object due to under-exposure or saturation in monitoring cameras and the like and an apparatus therefor.

One aspect of embodiments of the inventive concept is directed to provide an event detection method. The event detection method may include generating a plurality of images by successively capturing objects using a plurality of frames, wherein the plurality of frames are grouped into a plurality of groups based on whether the plurality of frames have the same or similar amounts of exposure, grouping images generated with frames corresponding to each of the plurality of groups, and determining whether a previously defined event occurs using the grouped images.

The plurality of groups may include at least a first group and a second group and an amount of exposure in frames which belong to the first group and an amount of exposure in frames which belong to the second group may be different from each other.

The plurality of groups may include at least a first group and a second group, and an exposure time in frames which belong to the first group and an exposure time in frames which belong to the second group may be different from each other, or an amplification gain in the frames which belong to the first group and an amplification gain in the frames which belong to the second group may be different from each other.

The event detection method may further include when there is an image in which the event occurs, storing information of a frame corresponding to the event and providing notification that the event occurs in the frame corresponding to the event.

The plurality of frames may be variably adjusted at their frame rates.

The generating of the plurality of images by successively capturing the objects using the plurality of frames may include determining whether under-exposure or saturation occurs in each of the plurality of images.

The event detection method may further include when the under-exposure occurs in a frame with the highest amount of exposure, adding a group of at least one frame with an amount of exposure which is higher than the highest amount of exposure.

The event detection method may further include when the saturation occurs in a frame with the lowest amount of exposure, adding a group of at least one frame with an amount of exposure which is lower than the lowest amount of exposure.

The event detection method may further include when the under-exposure occurs in a frame with an amount of exposure which is higher than the lowest amount of exposure, deleting a frame with an amount of exposure which is lower than that of the frame and when the saturation occurs in a frame with an amount of exposure which is lower than the highest amount of exposure, deleting a frame with an amount of exposure which is higher than that of the frame.

Another aspect of embodiments of the inventive concept is directed to provide an event detection method. The event detection method may include generating a plurality of images by successively capturing objects using a plurality of frames, wherein the plurality of frames are grouped into a plurality of groups based on whether the plurality of frames have the same or similar amounts of exposure and wherein each of the plurality of frames is divided into predetermined unit regions, grouping images generated with frames corresponding to each of the plurality of groups, and determining whether a previously defined event occurs using the grouped images.

The generating of the plurality of images by successively capturing the objects using the plurality of frames may include determining whether under-exposure and saturation occur according to regions of each of the images, when the under-exposure or the saturation occurs in a corresponding region of a corresponding image among the regions of each of the images, storing region information of a frame corresponding to the corresponding image, and when an image of a frame of a next period is generated, adjusting an amount of exposure of the corresponding region.

Another aspect of embodiments of the inventive concept is directed to provide an event detection apparatus. The event detection apparatus may include a controller configured to group a plurality of frames into a plurality of groups based on whether the plurality of frames have the same or similar amounts of exposure, a capture unit configured to generate a plurality of images by successively capturing objects using the plurality of frames, a comparison unit configured to group images generated with frames corresponding to each of the plurality of groups and to determine whether a previously defined event occurs using the grouped images, and a buffer configured to store frame information of the images.

The buffer may store at least one image selected among images which belong to the same group.

The controller may determine whether under-exposure and saturation of the images occur.

When the under-exposure occurs in a frame with the highest amount of exposure, the controller may add a group of at least one frame with an amount of exposure which is higher than the highest amount of exposure.

When the saturation occurs in a frame with the lowest amount of exposure, the controller may add a group of at least one frame with an amount of exposure which is lower than the lowest amount of exposure.

The controller may divide each of the plurality of frames into predetermined unit regions.

When under-exposure or saturation occurs in a corresponding region of a corresponding image among regions of each of the images, the buffer may store region information of a frame corresponding to the corresponding image and when an image of a frame of a next period is generated, the controller may adjust an exposure of amount of the corresponding region.

After each of images which belong to the same group is compared according to its regions, when there is a region where an event occurs, the buffer may store information of a frame corresponding to the region.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a flowchart illustrating an event detection method using frame grouping according to time according to an exemplary embodiment of the inventive concept;

FIG. 2 is a drawing illustrating a process of generating a plurality of images by successively capturing objects using a plurality of frames according to an exemplary embodiment of the inventive concept;

FIG. 3 is a drawing illustrating images in which objects are successively captured using a plurality of frames according to an exemplary embodiment of the inventive concept;

FIG. 4 is a flowchart illustrating a process of determining whether under-exposure and saturation of frames occur according to an exemplary embodiment of the inventive concept;

FIG. 5 is a drawing illustrating a process of adding a group of at least one frame according to an exemplary embodiment of the inventive concept;

FIG. 6 is a drawing illustrating an image captured with an added group of at least one frame according to an exemplary embodiment of the inventive concept;

FIG. 7 is a flowchart illustrating an event detection method using frame grouping according to time according to another exemplary embodiment of the inventive concept;

FIG. 8 is a flowchart illustrating a process of determining whether under-exposure and saturation occurs according to regions of images according to another exemplary embodiment of the inventive concept;

FIG. 9 is a drawing illustrating a process of adjusting an amount of exposure according to regions of images according to another exemplary embodiment of the inventive concept; and

FIG. 10 is a block diagram illustrating an event detection apparatus using frame grouping according to time according to an exemplary embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Hereinafter, a description will be given in detail for exemplary embodiments of the inventive concept with reference to the accompanying drawings.

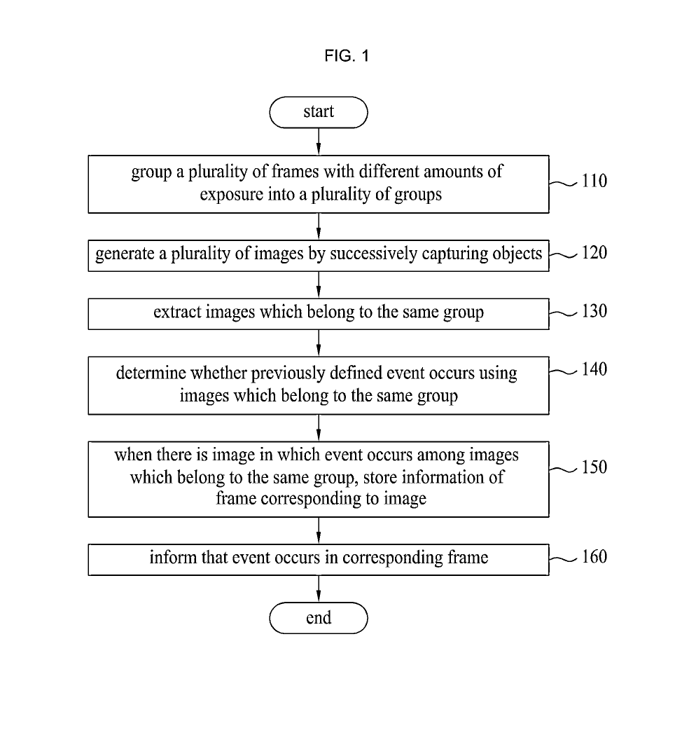

FIG. 1 is a flowchart illustrating an event detection method using frame grouping according to time according to an exemplary embodiment of the inventive concept.

Referring to FIG. 1, an event detection method using frame grouping according to time may include grouping a plurality of frames with different amounts of exposure into a plurality of groups (step 110), generating a plurality of images by successively capturing objects using the plurality of frames (step 120), extracting images which belong to the same group from the plurality of generated images (step 130), determining whether a previously defined event occurs using the images which belong to the same group (step 140), when there is an image in which the event occurs among the images which belong to the same group, storing information of a frame corresponding to the image (step 150), and providing notification that the event occurs in the corresponding frame (step 160).

In step 110, the plurality of frames with the different amounts of exposure may be grouped into the plurality of groups. Herein, the amount of exposure may be determined by multiplying an exposure time and an amplification gain together. According to an exemplary embodiment of the inventive concept, frames with the same or similar exposure time may be grouped into the same group. Frames with the same or similar amplification gains may be grouped into the same group.

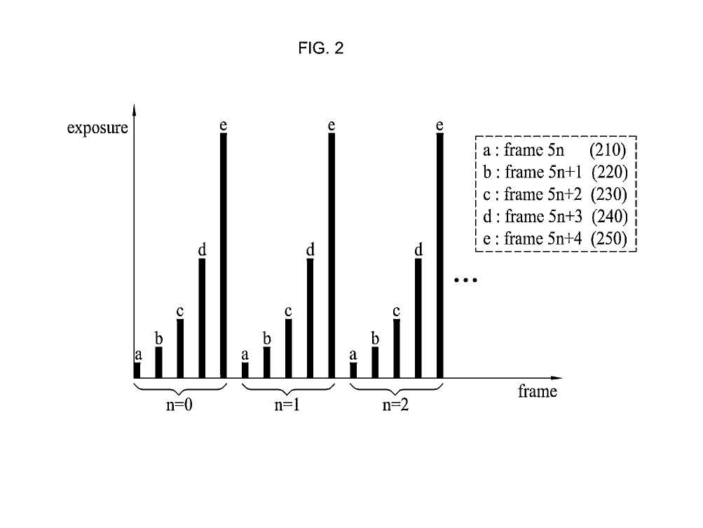

A plurality of frames which belong to the same group may be repeated at certain periods. For example, as shown in FIG. 2, a plurality of frames may be grouped into 5 groups, such as a group a, a group b, a group c, a group d, and a group e. Particularly, a plurality of frames with 5 different amounts of exposure may be grouped by frames with the same or similar amounts of exposure. For example, frames with the highest amount of exposure among the plurality of frames with the 5 different amounts of exposure may be grouped into the group e. Frames with a high amount of exposure may be grouped into the group d. Frames with an intermediate amount of exposure may be grouped into the group c. Frames with a low amount of exposure may be grouped into the group b. Frames with the lowest amount of exposure may be grouped into the group a.

When an object is captured at certain periods of 30 frames per second (fps), there are 30 frames per second. When the frames are grouped into 5 groups, 6 frames may be included in each of the 5 groups. Therefore, 6 images may be generated in each of the 5 groups.

Also, according to an exemplary embodiment of the inventive concept, when detection of an event is newly started, a frame rate may be adjusted. For example, a frame rate may be increased or decreased more or less than 30 fps. As a frame rate is increased, the accuracy of event detection may be more enhanced.

In step 120, the plurality of images may be generated by successively capturing the objects using the plurality of frames. For example, the plurality of frames may be grouped into a group of the highest amount of exposure, a group of the high amount of exposure, a group of the intermediate amount of exposure, a group of the low amount of exposure, and a group of the lowest amount of exposure. Herein, adjacent frames may be grouped into different groups.

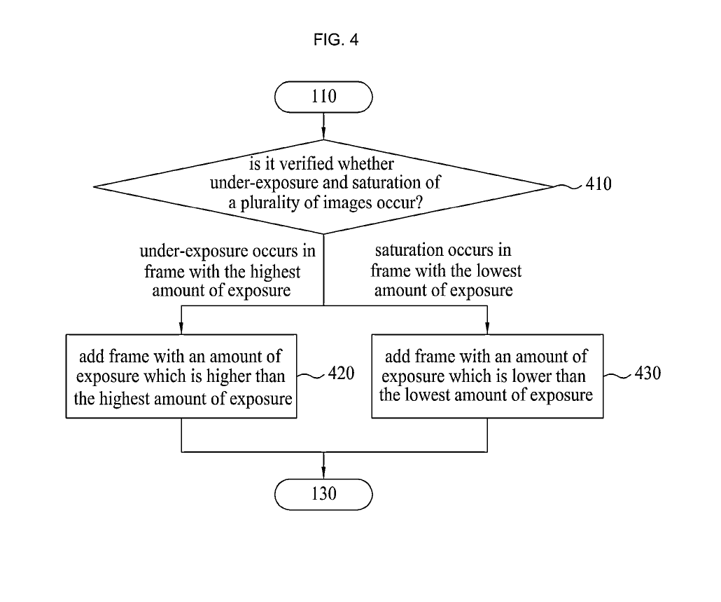

According to an exemplary embodiment of the inventive concept, it may be verified whether under-exposure and saturation of a plurality of frames occur. In other words, it may be verified whether under-exposure and saturation occur and a group of at least one frame may be added or deleted according to the verified result. Particularly, the verification whether the under-exposure and the saturation occur may be determined by analyzing a histogram of images. A description will be given in detail for addition or deletion of frames with reference to FIG. 4.

In step 130, the images which belong to the same group may be extracted from the plurality of generated images. After the objects are successively captured using the plurality of frames, the images which belong to the same group may be extracted. The plurality of frames with the different amounts of exposure may be grouped by frames with the same or similar amount of exposure. When the plurality of frames with the different amount of exposure are captured at certain periods of 30 fps and when the plurality of frames are grouped into 5 groups, images which belong to the same group among 30 images generated during 1 second may be 6 images.

In step 140, it may be determined about whether the previously defined event occurs using the images which belong to the same group. For example, because the frames which belong to the group a have a low amount of exposure, it is advantageous to determine whether an event occurs in relatively bright regions of images. Because the frames which belong to the group e have a high amount of exposure, it is advantageous to determine whether an event occurs in relatively dark regions of the images.

As such, according to an exemplary embodiment of the inventive concept, it may be separately determined whether an event occurs in each of several regions with different brightness in images, thereby making it possible to reduce a probability that the event will be missed.

In step 150, when there is the image in which the event occurs among the images which belong to the same group, information of the frame corresponding to the image may be stored. For example, when a new object, which does not exist in an image previously captured among 6 images which belong to the same group, is captured, the captured object may be detected. If an event is detected by this method, information of the detected frame may be stored. For example, when an event occurs in a third image, information indicating that the event is detected in the third image and information about a frame, such as an amount of exposure of a frame corresponding to the third image, may be stored in a buffer.

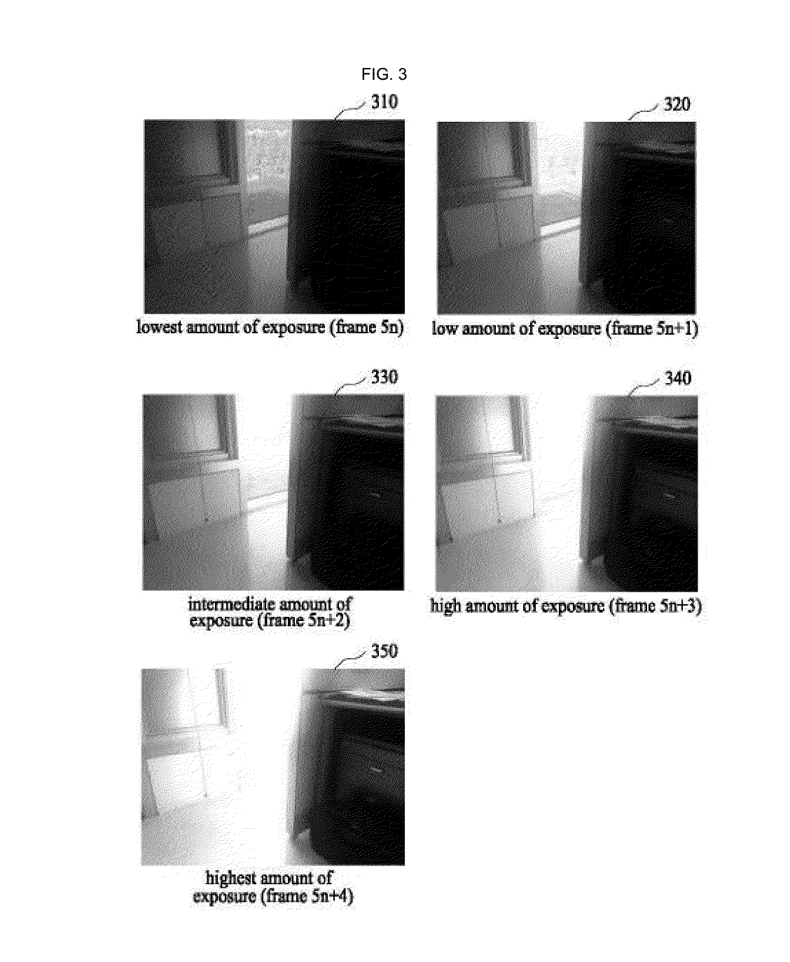

In step 160, it may be informed that the event occurs in the corresponding frame. When a new event is detected, it may be displayed or informed that the new event is detected. A description will be given in detail for an event detection method using frame grouping according to time with reference to FIGS. 2 and 3.

FIG. 2 is a drawing illustrating a process of generating a plurality of images by successively capturing objects using a plurality of frames according to an exemplary embodiment of the inventive concept.

Referring to FIG. 2, for example, a plurality of frames with different amounts of exposure may include 5 frames, such as a frame a 210, a frame b 220, a frame c 230, a frame d 240, and a frame e 250. The plurality of these frames may be captured at certain periods of 30 fps. The 5 frames may have the highest amount of exposure, a high amount of exposure, an intermediate amount of exposure, a low amount of exposure, and the lowest amount of exposure, respectively. The 5 frames with the different amounts of exposure may be successively and repeatedly captured. When n is 0, 5 frames, such as a frame a 210, a frame b 220, a frame c 230, a frame d 240, and a frame e 250, may be successively captured. When n is 1, 5 frames, such as a frame a 210, a frame b 220, a frame c 230, a frame d 240, and a frame e 250, may be successively captured. For example, when an object is captured at certain periods of 30 fps, because 30 frames may be captured per 1 second, a plurality of frames with 5 different amounts of exposure may be repeated 6 times during 1 second. Accordingly, when n is 0, 1, 2, 3, 4, and 5, frames with the same amounts of exposure may be captured 6 times during 1 second. As such, the plurality of frames with the 5 different amounts of exposure may be grouped by frames with similar amounts of exposure. One group may include 6 frames. For example, the frames with the lowest amount of exposure may be grouped into a group including the 6 frames a 210. Images generated by successively and repeatedly capturing the frames with the 5 different amounts of exposure may be as follows. The frame a 210 may be a frame 5n, the frame b 220 may be a frame 5n+1, and the frame c 230 may be a frame 5n+2. The frame d 240 may be a frame 5n+3 and the frame e 250 may be a frame 5n+4. Images captured with frames which belong to the same group may be compared among the captured 30 images. For example, 6 images captured with the frames a may include a frame 0, a frame 5, a frame 10, a frame 15, a frame 20, and a frame 29. An event may be detected by comparing the 6 images. When there is an image in which an event occurs among images captured with frames which belong to the same group, the information of a frame corresponding to the image may be stored and it may be informed that the event occurs in the corresponding frame.

FIG. 3 is a drawing illustrating images in which objects are successively captured using a plurality of frames according to an exemplary embodiment of the inventive concept.

Referring to FIG. 3, for example, 5 frames with different amounts of exposure may have the highest amount of exposure, a high amount of exposure, an intermediate amount of exposure, a low amount of exposure, and the lowest amount of exposure, respectively. The 5 frames with the different amounts of exposure may be successively and repeatedly captured. Referring to FIG. 3, there are a frame 5n 310 corresponding to an image captured with the lowest amount of exposure, a frame 5n+1 320 corresponding to an image captured with a low amount of exposure, a frame 5n+2 330 corresponding to an image captured with an intermediate amount of exposure, a frame 5n+3 340 corresponding to an image captured with a high amount of exposure, and a frame 5n+4 350 corresponding to an image captured with the highest amount of exposure. An under-exposure region may occur in a right lower portion and a left upper portion of the frame 5n 310 corresponding to the image captured with the lowest amount of exposure and an under-exposure region may occur in a right lower portion of the frame 5n+1 320 corresponding to the image captured with the low amount of exposure. On the other hand, a saturation region may occur in a middle upper portion of the frame 5n+2 330 corresponding to the image captured with the intermediate amount of exposure and a saturation region may occur in each of middle portions of the frame 5n+3 340 corresponding to the image captured with the high amount of exposure and the frame 5n+4 350 corresponding to the image captured with the highest amount of exposure.

In the event detection method using the frame grouping according to time according to an exemplary embodiment of the inventive concept, to also detect events in these under-exposure and saturation regions, frames according to time may be repeatedly captured with different amounts of exposure and images captured with frames which belong to the same group may be compared, thereby making it possible to detect events in the entire region of images.

FIG. 4 is a flowchart illustrating a process of determining whether under-exposure and saturation of frames occur according to an exemplary embodiment of the inventive concept.

The generating of a plurality of images by successively capturing objects using a plurality of frames may include determining whether under-exposure and saturation of the plurality of images occur (step 410), adding a group of at least one frame with an amount of exposure which is higher than the highest amount of exposure (step 420), and adding a group of at least one frame with an amount of exposure which is lower than the lowest amount of exposure (step 430).

When the plurality of images are generated by successively capturing the objects using the plurality of frames, in step 410, it may be verified whether the under-exposure and the saturation of the plurality of images occur. Images are repeatedly captured at certain periods using a plurality of frames with different amounts of exposure. For example, 5 frames with different amounts of exposure may be captured in order of a frame with the highest amount of exposure, a frame with a high amount of exposure, a frame with an intermediate amount of exposure, a frame with a low amount of exposure, and a frame with the lowest amount of exposure. Or, the 5 frames with the different amounts of exposure may be captured in opposite order of the frames. Herein, according to an exemplary embodiment of the inventive concept, it may be verified whether the under-exposure and the saturation of the plurality of frames occur. In other words, it may be verified whether the under-exposure and the saturation of the plurality of frames occur and a group of at least one frame may be added or deleted according to the verified result.

As a result of determining whether the under-exposure and the saturation of the plurality of frames occur, when the under-exposure occurs in the frame with the highest amount of exposure, in step 420, the group of at least one frame with the amount of exposure which is higher than the highest amount of exposure may be added. A group of at least one frame in which the under-exposure does not occur may be generated by adding the frame with the amount of exposure which is higher than the highest amount of exposure.

On the other hand, when the saturation occurs in the frame with the lowest amount of exposure, in step 430, the group of at least one frame with the amount of exposure which is lower than the lowest amount of exposure may be added. A frame in which the saturation does not occur may be generated by adding the group of at least one frame with the amount of exposure which is lower than the lowest amount of exposure. For example, there are 6 frames with different amounts of exposure by adding one frame. The frames may be captured at certain intervals of 30 fps. The frames may be grouped by frames with similar amounts of exposure. Herein, because 30 frames may be captured per 1 second, the number of frames which belong to the same group is 5. Accordingly, the frames which belong to the same group may be repeated 5 times during 1 second.

Also, as a result of determining whether the under-exposure and the saturation of the plurality of frames occur, the under-exposure may occur in a frame with an amount of exposure which is higher than the lowest amount of exposure. In this case, a frame with an amount of exposure which is lower than that of the frame with the amount of exposure which is higher than the lowest amount of exposure may be deleted. For example, when the under-exposure occurs in the frame with the low amount of exposure among the 5 frames with the highest amount of exposure, the high amount of exposure, the intermediate amount of exposure, the low amount of exposure, and the lowest amount of exposure, the frame with the lowest amount of exposure may be deleted.

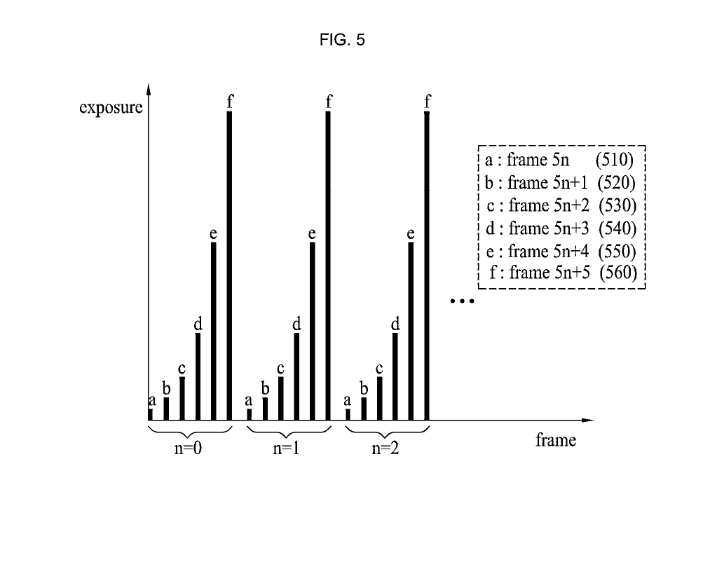

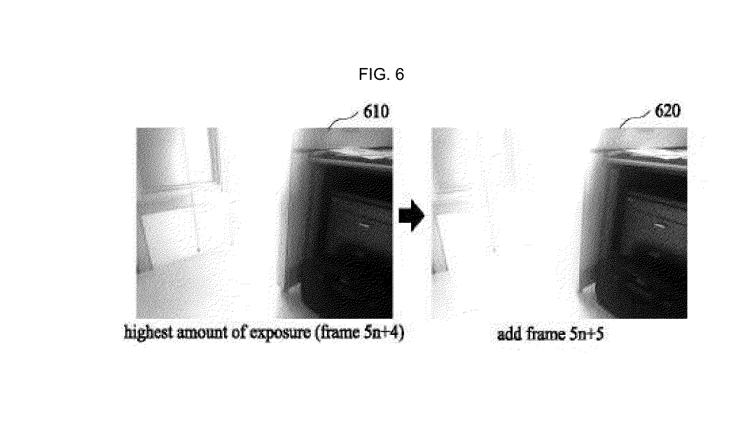

On the other hand, the saturation may occur in a frame with an amount of exposure which is lower than the highest amount of exposure. In this case, a frame which is an amount of exposure which is higher than that of the frame with the amount of exposure which is lower than the highest amount of exposure may be deleted. For example, when the saturation occurs in the frame with the high amount of exposure among the 5 frames with the highest amount of exposure, the high amount of exposure, the intermediate amount of exposure, the low amount of exposure, and the lowest amount of exposure, the frame with the highest amount of exposure may be deleted. A description will be given in detail for this with reference to FIGS. 5 and 6.

FIG. 5 is a drawing illustrating a process of adding a group of at least one frame according to an exemplary embodiment of the inventive concept.

Referring to FIG. 5, for example, a plurality of frames with different amounts of exposure may include 5 frames, such as a frame a 510, a frame b 520, a frame c 530, a frame d 540, and a frame e 550. The frames may be captured at certain periods of 30 fps. The 5 frames may have the highest amount of exposure, a high amount of exposure, an intermediate amount of exposure, a low amount of exposure, and the lowest amount of exposure, respectively. The 5 frames with the different amounts of exposure may be successively and repeatedly captured. The frame a 510 corresponding to an image captured with the highest amount of exposure may be indicated as a frame 5n, the frame b 520 corresponding to an image captured with the high amount of exposure may be indicated as a frame 5n+1, and the frame c 530 corresponding to an image captured with the intermediate amount of exposure may be indicated as a frame 5n+2. The frame d 540 corresponding to an image captured with the low amount of exposure may be indicated as a frame 5n+3 and the frame e 550 corresponding to an image captured with the lowest amount of exposure may be indicated as a frame 5n+4. Images captured with frames which belong to the same group may be compared therewith among the captured 30 images.

When images are successively captured using the plurality of frames, it may be verified whether under-exposure and saturation of the plurality of frames occur. In other words, it may be verified whether the under-exposure and the saturation of the plurality of frames occur, and a frame may be added or deleted according to the verified result. As a result of determining whether the under-exposure and the saturation of the plurality of frames occur, when the saturation occurs in the frame e 550 with the highest amount of exposure, a frame f 560 with an amount of exposure which is higher than the highest amount of exposure may be added. A frame in which the saturation does not occur may be generated by adding the frame f 560 with the amount of exposure which is higher than the highest amount of exposure. For example, there may be 6 frames with different amounts of exposure by adding one frame. The frames may be captured at certain periods of 30 fps. Herein, because 30 frames may be captured per 1 second, 6 frames may be repeated 5 times during 1 second. Accordingly, frames which belong to the same group may be captured 5 times during 1 second.

On the other hand, when the under-exposure occurs in the frame a 510 with the lowest amount of exposure, a frame with an amount of exposure which is lower than the lowest amount of exposure may be added. A frame in which the under-exposure does not occur may be generated by adding the frame with the amount of exposure which is lower than the lowest amount of exposure.

Also, as a result of determining whether the under-exposure and the saturation of the plurality of frames occur, the under-exposure may occur in a frame with an amount of exposure which is higher than the lowest amount of exposure. In this case, a frame with an amount of exposure which is lower than that of the frame with the amount of exposure which is higher than the lowest amount of exposure may be deleted. For example, when the under-exposure occurs in the frame b 520 with the low amount of exposure among the 5 frames with the highest amount of exposure, the high amount of exposure, the intermediate amount of exposure, the low amount of exposure, and the lowest amount of exposure, the frame a 510 with the lowest amount of exposure may be deleted.

On the other hand, the saturation may occur in a frame with an amount of exposure which is lower than the highest amount of exposure. In this case, a frame with an amount of exposure which is higher than that of the frame with the amount of exposure which is lower than the highest amount of exposure may be deleted. For example, when the saturation occurs in the frame d 540 with the high amount of exposure among the 5 frames with the highest amount of exposure, the high amount of exposure, the intermediate amount of exposure, the low amount of exposure, and the lowest amount of exposure, the frame e 550 with the highest amount of exposure may be deleted.

FIG. 6 is a drawing illustrating an image captured with an added frame according to an exemplary embodiment of the inventive concept.

Referring to FIG. 6, there are an image 610 captured with a frame 5n+4 with the highest amount of exposure and an image 620 captured with a frame 5n+5 after the frame 5n+5 with an amount of exposure which is higher than the highest amount of exposure is added. As a result of determining whether under-exposure and saturation of a plurality of frames occur, when the saturation occurs in the frame with the highest amount of exposure, a frame with an amount of exposure which is higher than the highest amount of exposure may be added. For example, it may be verified that the under-exposure occurs in a right lower portion of the image 610 with the frame 5n+4 with the highest amount of exposure. To prevent an under-exposure region from occurring, the frame 5n+5 with the amount of exposure which is higher than the highest amount of exposure may be added and captured. Assuming that a right lower portion may be verified on the image 620 captured with the frame 5n+5 after the frame 5n+5 with the amount of exposure which is higher than the highest amount of exposure is added, it may be verified that the image 620 is captured to be more vivid than the image 610 captured with the frame 5n+4 with the highest amount of exposure. Images in which the under-exposure and the saturation do not occur may be captured in the entire region of the images using this method.

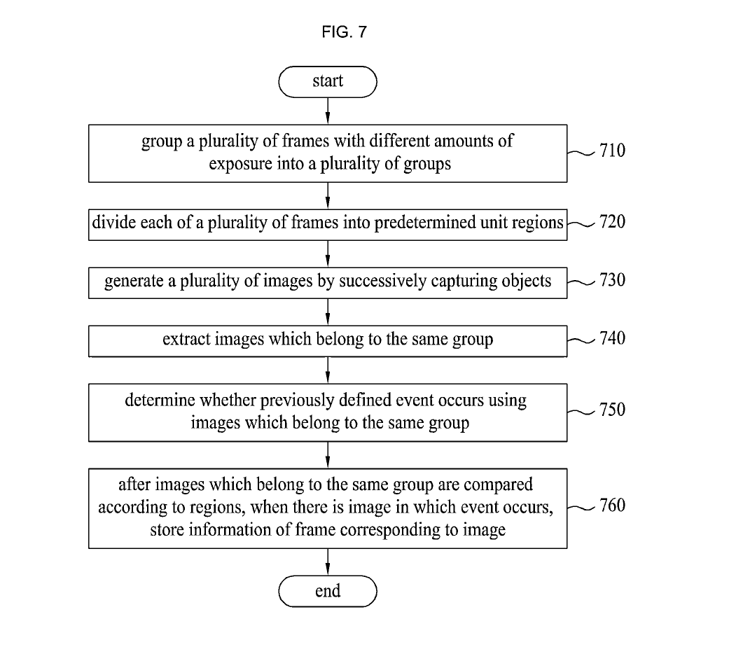

FIG. 7 is a flowchart illustrating an event detection method using frame grouping according to time according to another exemplary embodiment of the inventive concept.

Referring to FIG. 7, an event detection method using frame grouping according to time according to another exemplary embodiment of the inventive concept may include grouping a plurality of frames with different amounts of exposure into a plurality of groups (step 710), dividing each of the plurality of frames into predetermined unit regions (step 720), generating a plurality of images by successively capturing objects using the plurality of frames (step 730), extracting images which belong to the same group from the plurality of generated images (step 740), determining whether a previously defined event occurs using the images which belong to the same group (step 750), and after the images which belong to the same group are compared according to the regions, when there is an image in which the event occurs, storing information of a frame corresponding to the image (step 760).

In step 710, the plurality of frames with the different amounts of exposure may be grouped into the plurality of groups. A plurality of frames which belong to the same group may be repeated at certain periods. For example, a plurality of frames with 5 different amounts of exposure may be captured at certain periods of 30 fps. The plurality of frames with the 5 different amounts of exposure may be grouped by frames with similar amounts of exposure. The respective frames may have different amounts of exposure. For example, the 5 different amounts of exposure may be the highest amount of exposure, a high amount of exposure, an intermediate amount of exposure, a low amount of exposure, and the lowest amount of exposure, respectively. Because the plurality of frames with the different amounts of exposure are captured at the certain periods of 30 fps, images which belong to the same group may be 6 images. Also, when detection of an event is newly started, a frame rate may be adjusted. As a frame rate is increased, the accuracy of event detection may be more enhanced.

In step 720, each of the plurality of frames may be divided into predetermined unit regions. For example, when there are 3 frames with different amounts of exposure, each of the 3 frames may be divided into predetermined unit regions. For example, a frame with the highest amount of exposure may be divided into the 4 same quadrangle unit regions among 3 frames with the highest amount of exposure, an intermediate amount of exposure, and the lowest amount of exposure. However, the scope and spirit of the inventive concept may not be limited to the quadrangle unit region. Each of the two frames with the intermediate amount of exposure and the lowest amount of exposure may be divided into predetermined unit regions. As such, when each of frames is divided into unit regions, an event may be detected using fewer frames than that of a method of using frames without dividing each of the frames into unit regions.

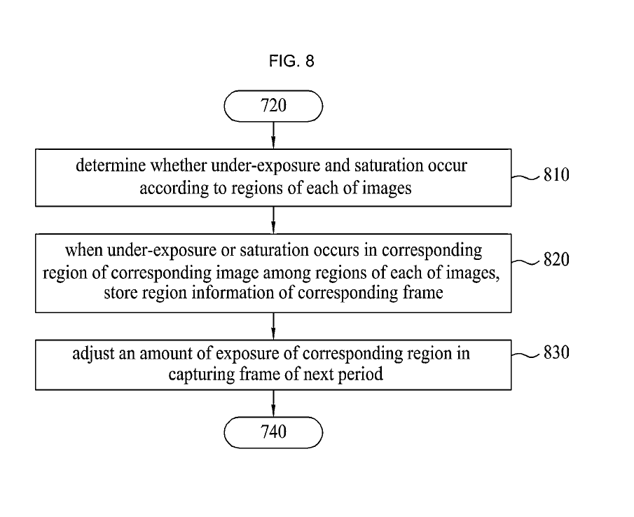

In step 730, the plurality of images may be generated by successively capturing the objects using the plurality of frames. Images may be successively captured at predetermined time intervals using the plurality of frames, each of which is divided into predetermined unit regions, with different amounts of exposure. For example, 3 frames may be captured in order of the frames with the highest amount of exposure, the intermediate amount of exposure, and the lowest amount of exposure. Or, the 3 frames may be captured in opposite order of the frames. Herein, according to another exemplary embodiment of the inventive concept, it may be verified whether under-exposure and saturation occur according to regions of frames. In other words, it may be verified whether the under-exposure and the saturation occur according to the regions of the frames and amounts of exposure according to the regions of the frames may be adjusted according to the verified result. A description will be given in detail for this with reference to FIG. 8.

In step 740, the images which belong to the same group may be extracted from the plurality of generated images. After the objects are successively captured using the plurality of frames, the images which belong to the same group may be extracted. For example, there may be a plurality of frames with 3 different amounts of exposure and the frames may be captured at certain intervals of 30 fps. The plurality of frames with the 3 different amounts of exposure may be grouped by frames with similar amounts of exposure. Because the plurality of frames with the different amounts of exposure are captured at the certain periods of 30 fps, images which belong to the same group may be 10 images. Accordingly, the frames which belong to the same group may be captured 3 times during 1 second.

In step 750, it may be determined whether the previously defined event occurs using the images which belong to the same group. For example, the plurality of frames with the 3 different amounts of exposure may be grouped by frames with similar amounts of exposure. When the plurality of frames with the different amounts of exposure are captured at the certain periods of 30 fps, images which belong to the same group may be 10 images. Accordingly, it may be verified whether an event occurs by comparing the 10 images which belong to the same group among 30 images.

In step 760, after the mages which belong to the same group are compared according the regions, when there is the image in which the event occurs, information of the frame corresponding to the image may be stored. For example, after the 10 frames which belong to the same group are compared therewith according to regions, when a new object which does not exist in a previously captured image is captured, the captured object may be detected. If an event is detected by this method, information of the detected frame may be stored. For example, when an event occurs in a first region of a third frame, information indicating that the event is detected in the first region of the third frame and information about the third frame, such as an amount of exposure of the third frame, may be stored in a buffer. Also, it may be informed that the event occurs in the corresponding frame. When a new event is detected, it may be displayed or informed that the new event is detected.

FIG. 8 is a flowchart illustrating a process of determining whether under-exposure and saturation occurs according to regions of images according to another exemplary embodiment of the inventive concept.

The generating of a plurality of images by successively capturing objects using a plurality of frames may include determining whether under-exposure and saturation occur according to regions of each of the images (step 810), when the under-exposure or the saturation occurs in a corresponding region of a corresponding image among the regions of each of the images, storing region information of a frame corresponding to the corresponding image (step 820), and when an image of a frame of a next period is generated, adjusting an amount of exposure of the corresponding region (step 830).

In step 810, it may be verified whether the under-exposure and the saturation occur according to regions of each of the images. Images may be successively captured at certain periods using a plurality of frames, each of which is divided into predetermined unit regions, with different amounts of exposure. For example, 3 frames may be captured in order of the frames with the highest amount of exposure, an intermediate amount of exposure, and the lowest amount of exposure. Or, the 3 frames may be captured in opposite order of the frames. Herein, according to another exemplary embodiment of the inventive concept, it may be verified whether under-exposure and saturation occur according to regions of each of frames. In other words, it may be verified whether the under-exposure and the saturation occur according to the regions of each of the frames, and amounts of exposure may be adjusted according to the regions of each of the frames according to the verified result. For example, the frame with the highest amount of exposure may be divided into the 4 same quadrangle regions among the 3 frames with the highest amount of exposure, the intermediate amount of exposure, and the lowest amount of exposure. It may be verified whether under-exposure and saturation occur in each of the 4 regions of the frame. Each of the two frames with the intermediate amount of exposure and the lowest amount of exposure may be divided into predetermined unit regions. It may be verified whether under-exposure and saturation occur in each of the regions of the frames.

In step 820, when the under-exposure or the saturation occurs in a corresponding region of a corresponding image among the regions of each of the images, region information of a frame corresponding to the corresponding image may be stored. For example, when the under-exposure and the saturation do not occur in first to third regions of the frame with the highest amount of exposure and when under-exposure occurs in a fourth region of the frame with the highest amount of exposure, information indicating that the under-exposure occurs in the fourth region of the frame with the highest amount of exposure may be stored in a buffer. Also, when a frame with the highest amount of exposure is captured in a next period, an event may be detected in only the first to third regions.

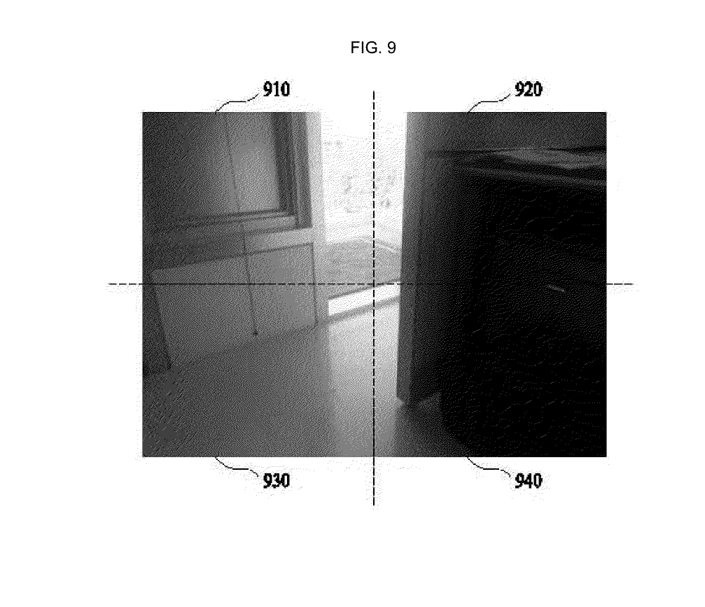

In step 830, when an image of a frame of a next period is generated, an amount of exposure of the corresponding region may be adjusted. For example, when the under-exposure occurs in the fourth region of the frame with the highest amount of exposure, if a next turn frame with the highest amount of exposure is captured, an amount of exposure of the fourth region may be adjusted to prevent the under-exposure from occurring. Herein, amounts of exposure in the first to third regions of the frame with the highest amount of exposure may be maintained without change. In this case, a buffer for storing exposure levels may be further needed in addition to a buffer for storing information of a corresponding frame. A description will be given in detail for this with reference to FIG. 9.

FIG. 9 is a drawing illustrating a process of adjusting an amount of exposure according to regions of images according to another exemplary embodiment of the inventive concept.

Referring to FIG. 9, for example, an image shown in FIG. 9 may be an image captured with a frame with the lowest amount of exposure. This image may be divided into a first region 910, a second region 920, a third region 930, and a fourth region 940. Herein, it may be verified whether under-exposure and saturation occur according to the first to fourth regions of the frame. It may be verified that the under-exposure and the saturation do not occur in the first to third regions of the frame with the lowest amount of exposure and an under-exposure region occurs in the fourth region of the frame. In this case, information of the fourth region where the under-exposure region occurs may be stored. For example, information indicating that the under-exposure occurs in the fourth region of the frame with the lowest amount of exposure may be stored in a buffer. Thereafter, an amount of exposure of the fourth region may be adjusted in capturing a frame with the lowest amount of exposure in a next period, and an event may be detected in only the first to third regions. When the frame with the lowest amount of exposure in the next period may be captured, the amount of exposure may be adjusted, thereby making it possible to prevent the under-exposure from occurring. Herein, amounts of exposure in the first to third regions of the frame with the lowest amount of exposure may be maintained without change. In this case, a buffer for storing exposure levels may be further needed in addition to a buffer for storing information of a corresponding frame.

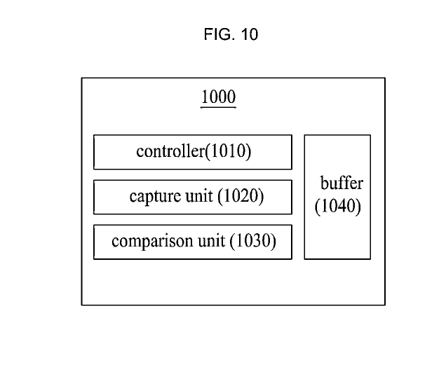

FIG. 10 is a block diagram illustrating an event detection apparatus using frame grouping according to time according to an exemplary embodiment of the inventive concept.

An event detection apparatus 1000 using frame grouping according to time may include a controller 1010, a capture unit 1020, a comparison unit 1030, and a buffer 1040.

The controller 1010 may group a plurality of frames with different amounts of exposure into a plurality of groups. Also, the controller 1010 may control the capture unit 1020 to successively capture images using the plurality of frames and may extract images which belong to the same group from the plurality of captured images. Also, the controller 1010 may adjust a frame rate. For example, the number of frames with different amounts of exposure may be 5 and the frames may be captured at certain intervals of 30 fps. A plurality of frames which belong to the same group may be repeated at certain periods. Also, when detection of an event is newly started, the controller 1010 may adjust a predetermined time interval. For example, a plurality of frames with 5 different amounts of exposure may be captured at certain periods of 30 fps. The plurality of frames with the 5 different amounts of exposure may be grouped by frames with similar amounts of exposure. The respective frames may have different amounts of exposure. For example, the 5 different amounts of exposure may be the highest amount of exposure, a high amount of exposure, an intermediate amount of exposure, a low amount of exposure, and the lowest amount of exposure, respectively.

Also, the controller 1010 may determine whether under-exposure and saturation of the plurality of frames occur. When the under-exposure occurs in the frame with the highest amount of exposure, the controller 1010 may add a frame with an amount of exposure which is higher than the highest amount of exposure. On the other hand, when the saturation occurs in the frame with the lowest amount of exposure, the controller 1010 may add a frame with an amount of exposure which is lower than the lowest amount of exposure. Also, as a result of determining whether the under-exposure and the saturation of the plurality of frames occur, the under-exposure may occur in a frame with an amount of exposure which is higher than the lowest amount of exposure. In this case, the controller 1010 may delete a frame with an amount of exposure which is lower than that of the frame with the amount of exposure which is higher than the lowest amount of exposure. For example, when the under-exposure occurs in the frame with the lowest amount of exposure among 5 frames with the highest amount of exposure, the high amount of exposure, the intermediate amount of exposure, the low amount of exposure, and the lowest amount of exposure, the controller 1010 may delete the frame with the lowest amount of exposure. On the other hand, when the saturation may occur in a frame with an amount of exposure which is lower than the highest amount of exposure. In this case, the controller 1010 may delete a frame with an amount of exposure which is higher than that of the frame with the amount of exposure which is lower than the highest amount of exposure. For example, when the saturation occurs in the frame with the high amount of exposure among the 5 frames with the highest amount of exposure, the high amount of exposure, the intermediate amount of exposure, the low amount of exposure, and the lowest amount of exposure, the controller 1010 may delete the frame with the highest amount of exposure.

Also, the controller 1010 may divide each of the plurality of frames into predetermined unit regions. For example, the controller 1010 may divide the frame with the highest amount of exposure into the 4 same quadrangle unit regions. However, the scope and spirit of the inventive concept may not be limited to the quadrangle unit region. When the under-exposure or the saturation occurs in a corresponding region among regions of a frame, the controller 1010 may adjust an amount of exposure of the corresponding region in capturing a frame of a next period.

The capture unit 1020 may generate a plurality of images by successively capturing objects using the plurality of frames. The capture unit 1020 may successively capture images using the plurality of frames. For example, the capture unit 1020 may successively capture objects using the plurality of frames with the 5 different amounts of exposure and may capture the frames at certain intervals of 30 fps. The plurality of frames with the 5 different amounts of exposure may be grouped by frames with similar amounts of exposure. Because the plurality of frames with the different amounts of exposure may be captured at certain periods of 30 fps, images which belong to the same group may be 6 images. Accordingly, the images which belong to the same group may be captured 6 times during 1 second.

The comparison unit 1030 may compare the images which belong to the same group among the plurality of generated images. For example, there may be the 5 frames with the different amounts of exposure and the frames may be captured at the certain periods of 30 fps. The plurality of frames with the different amounts of exposure may be grouped by frames with similar amounts of exposure. Herein, because 30 frames may be captured per 1 second, the 5 frames with the different amounts of exposure may be repeated 6 times during 1 second. Accordingly, the frames which belong to the same group may be captured 6 times during 1 second. Images which belong to the same group may be compared among images captured with 30 frames to determine whether an event occurs. When there is a frame in which the event occurs among the images which belong to the same group, information of the corresponding frame may be stored in the buffer 1040. For example, when a new object, which does not exist in an image previously captured among the 6 images which belong to the same group, is captured, it may be detected. When the event is detected by this method, frame information of the detected image may be stored. For example, when an event occurs in a third image, information indicating that the event is detected in the third image and information about a frame, such as an amount of exposure of the frame corresponding to the third image, may be stored in the buffer 1040. Also, in case of dividing each of the frames according to regions, the comparison unit 1030 may compare each of the images which belong to the same group according to the regions among the plurality of captured images.

The buffer 1040 may store information of the frames. When there is an image in which the event occurs among the images which belong to the same group, the buffer 1040 may store information of a frame corresponding to the image. Also, in case of dividing each of the frames according to regions, the buffer 1040 may store region information of the corresponding frame. When under-exposure or saturation occurs in a corresponding region among regions of an image, the buffer 1040 may store region information of a frame corresponding to the image. For example, when the under-exposure and the saturation do not occur in first to third regions of the frame with the highest amount of exposure, and when the under-exposure occurs in a fourth region of the frame, information indicating that the under-exposure occurs in the fourth region of the frame with the highest amount of exposure may be stored in the buffer 1040.

According to an exemplary embodiment of the inventive concept, the event detection apparatus may detect the event in the under-exposure or saturation region by grouping the plurality of frames with the different amounts of exposure according to time and detecting the event. According to another exemplary embodiment of the inventive concept, the event detection apparatus may reduce the number of needed frames by dividing each of the plurality of frames, which are grouped and have the different amounts of exposure, according to regions.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. An event detection method comprising:
generating a plurality of images by successively capturing objects using a plurality of frames, wherein the plurality of frames are grouped into a plurality of groups based on whether the plurality of frames have the same or similar amounts of exposure;
grouping images generated with frames corresponding to each of the plurality of groups; and
determining whether a previously defined event occurs using the grouped images.

2. The event detection method of claim 1, wherein the plurality of groups comprises at least a first group and a second group, and
wherein an amount of exposure in frames which belong to the first group and an amount of exposure in frames which belong to the second group are different from each other.

3. The event detection method of claim 1, wherein the plurality of groups comprises at least a first group and a second group, and
wherein an exposure time in frames which belong to the first group and an exposure time in frames which belong to the second group are different from each other, or
wherein an amplification gain in the frames which belong to the first group and an amplification gain in the frames which belong to the second group are different from each other.

4. The event detection method of claim 1, further comprising:
when there is an image in which the event occurs, storing information of a frame corresponding to the event; and
providing notification that the event occurs in the frame corresponding to the event.

5. The event detection method of claim 1, wherein frame rates of the plurality of frames are variably adjusted.

6. The event detection method of claim 1, wherein the generating of the plurality of images by successively capturing the objects using the plurality of frames comprises:
determining whether under-exposure or saturation occurs in each of the plurality of images.

7. The event detection method of claim 6, further comprising:
when the under-exposure occurs in a frame with the highest amount of exposure, adding a group of at least one frame with an amount of exposure which is higher than the highest amount of exposure in the existing frame groups.

8. The event detection method of claim 6, further comprising:
when the saturation occurs in a frame with the lowest amount of exposure, adding a group of at least one frame with an amount of exposure which is lower than the lowest amount of exposure in the existing frame groups.

9. The event detection method of claim 6, further comprising:
when the under-exposure occurs in a frame with an amount of exposure which is higher than the lowest amount of exposure, deleting a frame with an amount of exposure which is lower than that of the frame; and
when the saturation occurs in a frame with an amount of exposure which is lower than the highest amount of exposure, deleting a frame with an amount of exposure which is higher than that of the frame.

10. An event detection method comprising:
generating a plurality of images by successively capturing objects using a plurality of frames, wherein the plurality of frames are grouped into a plurality of groups based on whether the plurality of frames have the same or similar amounts of exposure and wherein each of the plurality of frames is divided into predetermined unit regions;
grouping images generated with frames corresponding to each of the plurality of groups; and
determining whether a previously defined event occurs using the grouped images.

11. The event detection method of claim 10, wherein the generating of the plurality of images by successively capturing the objects using the plurality of frames comprises:
determining whether under-exposure and saturation occur according to regions of each of the images;
when the under-exposure or the saturation occurs in a corresponding region of a corresponding image among the regions of each of the images, storing region information of a frame corresponding to the corresponding image; and
when an image of a frame of a next period is generated, adjusting an amount of exposure of the corresponding region.

12. An event detection apparatus comprising:
a controller configured to group a plurality of frames into a plurality of groups based on whether the plurality of frames have the same or similar amounts of exposure;
a capture unit configured to generate a plurality of images by successively capturing objects using the plurality of frames;
a comparison unit configured to group images generated with frames corresponding to each of the plurality of groups and to determine whether a previously defined event occurs using the grouped images; and
a buffer configured to store frame information of the images.

13. The event detection apparatus of claim 12, wherein the buffer stores at least one image selected among images which belong to the same group.

14. The event detection apparatus of claim 12, wherein the controller determines whether under-exposure and saturation of the images occur.

15. The event detection apparatus of claim 14, wherein when the under-exposure occurs in a frame with the highest amount of exposure, the controller adds a group of at least one frame with an amount of exposure which is higher than the highest amount of exposure in the existing frame groups.

16. The event detection apparatus of claim 14, wherein when the saturation occurs in a frame with the lowest amount of exposure, the controller adds a group of at least one frame with an amount of exposure which is lower than the lowest amount of exposure in the existing frame groups.

17. The event detection apparatus of claim 12, wherein the controller divides each of the plurality of frames into predetermined unit regions.

18. The event detection apparatus of claim 12, wherein when under-exposure or saturation occurs in a corresponding region of a corresponding image among regions of each of the images, the buffer stores region information of a frame corresponding to the corresponding image, and
wherein when an image of a frame of a next period is generated, the controller adjusts an exposure of amount of the corresponding region.

19. The event detection apparatus of claim 12, wherein after each of images which belong to the same group is compared according to its regions, when there is a region where an event occurs, the buffer stores information of a frame corresponding to the region.
